(19) United States
(12) Patent Application Publication
(10) Pub. No.: US 2013/0110818 A1
(43) Pub. Date: May 2, 2013

(54) PROFILE DRIVEN EXTRACTION

(71) Applicants: Eamonn O'Brien-Strain, San Francisco, CA (US); Qian Lin, Santa Clara, CA (US); Jerry J. Liu, Sunnyvale, CA (US)

(72) Inventors: Eamonn O'Brien-Strain, San Francisco, CA (US); Qian Lin, Santa Clara, CA (US); Jerry J. Liu, Sunnyvale, CA (US)

(21) Appl. No.: 13/284,316

(22) Filed: Oct. 28, 2011

(51) Int. Cl. G06F 17/30; G06F 3/048

(52) U.S. Cl. 707/713; 715/760; 707/758; 707/E17.108

(57) ABSTRACT

Methods, devices, and systems for profile driven extraction are provided. An example of profile driven extraction includes utilizing an extraction profile created for extracting a subset of content from a particular type of web page, extracting the subset of the content from a number of web pages with a computing device, and transforming the subset of the content with the computing device into a displayable format.

### BACKGROUND

The internetwork (e.g., the Internet) provides users throughout the world the ability to access large amounts and varieties of information at previously unthinkable speeds. Indeed, with the advent of the Internet, for instance, other means of communication, such as newspapers, telephones, and mail, are becoming obsolete and consumers are looking to the various web pages on, for instance, the World Wide Web (e.g., the WWW, W3, Web, etc.) for information, services, and products. However, with the inclusion of multimedia content, embedded advertising, and other online services, these web pages have become substantially more complex. For instance, a web page may include additional peripheral information such as background imagery, advertisements, navigational menus, headers, footers, as well as separate links to additional content located throughout the Internet.

Therefore, users of a web page may desire to view, utilize, and/or adapt the main content within the web page. Selecting or otherwise using that desired portion of the content on the web page may require that the user carefully distinguish between the desirable and undesirable content and retrieve only those desirable portions of the web page. Easier selection of those portions of the web site or web page that the user desires could greatly increase productivity as well as enhance the user's experience while accessing the web page.

### BRIEF DESCRIPTION OF THE DRAWINGS

FIG. 1 is a diagram of an illustrative system for profile driven extraction of content in web pages according to the present disclosure.

FIG. 2 is a block diagram illustrating an example of a method for profile driven extraction according to the present disclosure.

FIG. 3 illustrates an example of creating an extraction profile according to the present disclosure.

FIG. 4 illustrates an example of a system for profile driven extraction according to the present disclosure.

FIGS. 5A-5C illustrate an example implementation of profile driven extraction according to the present disclosure.

FIG. 6 is a block diagram illustrating an example of a computing device readable medium with processing resources for profile driven extraction according to the present disclosure.

### DETAILED DESCRIPTION

Web sites and web pages provide an inexpensive and convenient way to make information available (e.g., display) to individuals, including consumers of products, those with interest in up-to-date reportage of news, sports, finance, etc., those with interest in historical accounts, students, and media enthusiasts in general, among others. However, as the inclusion of multimedia content, embedded advertising, and online services becomes increasingly prevalent in web pages, the web pages themselves have become substantially more complex. For instance, in addition to their main content, web pages may display auxiliary content, such as background imagery, advertisements, navigation menus, and links to additional content, among other content that may not convey information of relevance or interest to an individual (e.g., web site and web page owners and/or developers, a viewer, visitor, user, etc.) that has constructed, presented, displayed, and/or accessed the web sites or web pages.

Web site and web page owners and/or developers, or individuals that access web pages may desire to utilize (e.g., present, display, print, save, etc.) only a portion of the information presented in a web page. Automatic extraction (e.g., selection) of desired content in web pages, as described in the present disclosure, can reduce extraneous and/or undesired content, which may streamline utilization of a number of workflows. For instance, a user may desire to print a physical copy of an article located at an online news website without printing other content presented on the web page containing the article (e.g., the background imagery, advertisements, navigation menus, and links to additional content, etc.). Additionally, a user may desire to display only web content pertinent to terms in a search query on a computing device that has a monitor of limited size (e.g., on a screen of a portable communication device, such as a mobile smart phone or other mobile application). Similarly, an owner and/or developer of a web site and/or web page may desire to adapt a web page into a document with a different format, for example, a marketing brochure that does not include content displayed on the web page that is superfluous to the marketing brochure, among other reasons. Other applications that may benefit from automatic extraction of desired content in web pages include, for example, search, information retrieval, information management, archiving, and other applications.

Examples of the present disclosure include methods, devices, and systems for profile driven extraction. Such profile driven extraction can be used for the applications described in the present disclosure, although the profile driven extraction is not limited to such applications. An example of profile driven extraction includes utilizing an extraction profile created for extracting a subset of content from a particular web site or type of web page, extracting the subset of the content from a number of web pages with a computing device, and transforming the subset of the content with the computing device into a displayable format.

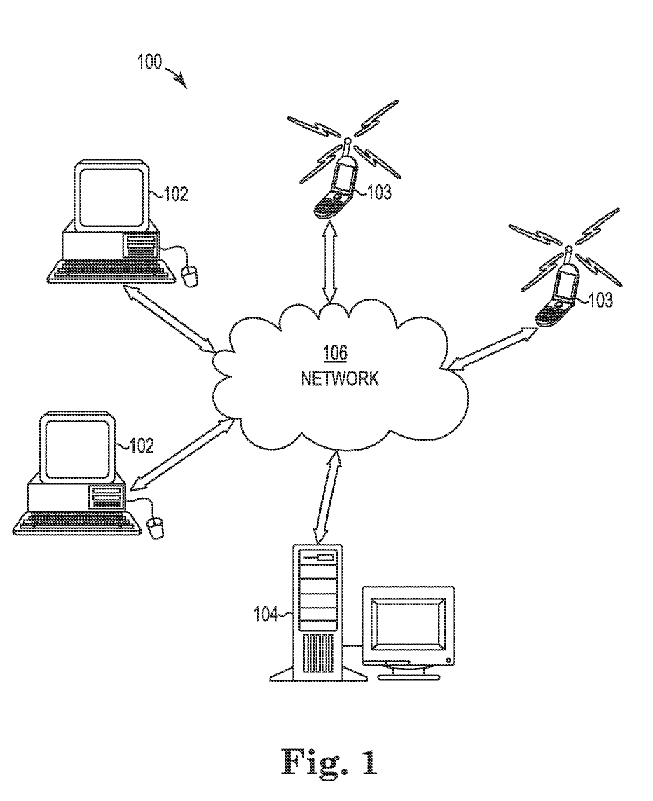

FIG. 1 is a diagram of an illustrative system for profile driven extraction of content in web pages according to the present disclosure. FIG. 1 illustrates an example of a network system 100. As indicated in FIG. 1, the system 100 can include a number of network accessible devices (e.g., client computers 102, portable communication devices having mobile applications 103, and/or at least one networked server computer 104) each having and/or connected to a number of monitors (e.g., screens) for display of text and/or visual images, having and/or connected to a number of printers for printing hard copies of text and/or visual images, and/or having and/or connected to memory for saving (e.g., in files) of text and/or visual images.

In the detailed description of the present disclosure, reference is made to the accompanying drawings that form a part hereof, and in which is shown by way of illustration examples of how the disclosure may be practiced. These examples are described in sufficient detail to enable those of ordinary skill in the art to practice the examples described in this disclosure, and it is to be understood that other examples may be utilized and that process, electrical, and/or structural changes may be made without departing from the scope of the present disclosure. Further, where appropriate, as used herein, “for example” and “by way of example” should each be understood as an abbreviation for “by way of example and not by way of limitation”.

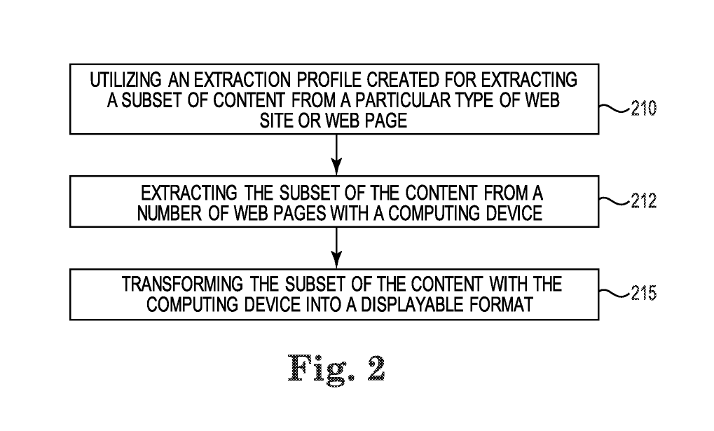

The figures herein follow a numbering convention in which the first digit or digits correspond to the drawing figure number and the remaining digits identify an element or component in the drawing. Similar elements or components between different figures may be identified by the use of similar digits. For example, 104 may reference element “104” in FIG. 1, and a similar element may be referenced as “204” in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

As used herein, the term “includes” means “includes but not limited to” and the term “including” means “including but not limited to”. As used herein, the terms “web site” and “web page” are meant to be understood broadly as any site or document that can be accessed by a Uniform Resource Locator (URL) on the Internet or other networks. The terms may be used interchangeably in the specification and claims. A web page may, therefore, be retrieved from a server over a network connection (e.g., to a web site) and viewed in a web browser application. Additionally, as used herein, the terms “user” and “end user” are meant to be understood broadly as any person viewing or otherwise utilizing a web site or web page. Therefore, an owner or administrator of a web site or web page, a user of a computing system having accessed a web site or web page, or any other person may be a user or end user.

As illustrated in FIG. 1, the client computers 102, portable communication devices 103, and/or server computers 104 are shown as being configured to communicate via a network 106. In various examples, the network 106 can include wired and wireless connections to the Internet and/or the WWW, local area networks (LANs), personal area network (PAN), and/or wide area networks (WANs) connected through a number of different protocols. In addition to the devices shown in FIG. 1, substantially any network-enabled device could be used to practice examples of the present disclosure, including notebook computers, handheld computers, mobile telephones, media players, gaming consoles, among others. In addition to communicating with the server computer 104, the client computers 102, the portable communication devices 103, and/or the server computers 104 also can directly access electronic documents in the form of word processing documents, images and graphics, PDFs, video files, audio files, and network 106 content (e.g., in the form of web sites and web pages) via the network 106 using an appropriate program, peer to peer file sharing, FTP, TCP/IP, and/or using a network browser.

As described in greater detail herein, the client computers 102, portable communication devices 103, and/or server computers 104 can be configured to identify electronic web page content that is to be displayed, printed, and/or saved and further to identify web page content that is to be removed prior to the content being displayed, printed, and/or saved. In various examples, the client computers 102, portable communication devices 103, and/or server computers 104 can be configured to remove at least some of the web page content (e.g., footers, headers, source formatting, comments and/or annotations, citations, image or photo background, web site navigation features, hyperlinks to other web pages, online advertisements, and the like) to enhance display and/or printout format and reduce clutter. In some examples, client computers 102, portable communication devices 103, and/or server computers 104 can be configured to create and display a newly formatted document that can be used to generate a printout and/or saved as such, among other functionalities.

The present disclosure describes various examples by which main content from a particular web page or type of web page (e.g., accessed at a number of web sites) can be extracted and/or transformed automatically and accurately using a custom extraction profile created for the particular web page or type of web page. The extraction profile can, in various examples, include preprogrammed rules for searching for a particular web site and/or web page using query terms and extraction rules for each particular type of web page that specify how the main content can be extracted from that type of web page.

As such, the present disclosure enables finding a particular web site and/or web page and extracting main content from the web pages automatically with just a simple search based on query terms and/or a simple “pick-and-click” in a user interface. The extraction can be accurate in extracting out the main content of web pages, while reducing extraction of content (e.g., advertisements, navigation links, etc.) that may not be of interest or relevance to an individual accessing the web pages.

Accordingly, the present disclosure describes profile driven extraction that is that is parameterized by an extraction profile to work well for the web pages on one particular web site and/or one particular type of web page used on a number of web sites. The present disclosure also describes an authoring system for creating many such parameterizations (e.g., using a trainer), each for a different web site and/or a different type of web page.

In prior attempts at content extraction, there has been a three-way trade-off between accuracy, degree of automation, and range of applicability. That is, one could: use generic automated algorithms on arbitrary web pages, but risk selecting unwanted content or missing some of the main content; rely on a user to make manual adjustments to the selected content, but thereby sacrifice automation; only extract from particular types of web pages, taking advantage of known structures of such web pages, but sacrifice range of applicability. However, utilizing the examples of profile driven extraction described in the present disclosure to create such parameterizations, each for the different web site and/or the different type of web page, limitations of the three-way trade-off can be reduced.

FIG. 2 is a block diagram illustrating an example of a method for profile driven extraction according to the present disclosure. Unless explicitly stated, the method examples described herein are not constrained to a particular order or sequence. Additionally, some of the described method examples, or elements thereof, can occur or be performed at the same, or substantially the same, point in time.

As described in the present disclosure, profile driven extraction includes utilizing an extraction profile created for extracting a subset of content from a particular web site or type of web page, as shown in block 210 of FIG. 2. The subset of the content is extracted from a number of web pages with a computing device, as shown in block 212. Such a computing device includes those described in the present disclosure, however, the computing device is not so limited. As shown in block 215, the subset of the content is transformed with the computing device into a displayable format.

In some examples, a trainer can create the extraction profile for the particular type of web site or web page. The trainer creating the extraction profile for the particular type of web site or web page can, in various examples, be selected from a group that includes: an entity associated with a web site that can provide access to the particular type of web site or web page; a hardware, firmware, or software provider that can provide computer-executable instructions that include the extraction profile; and/or a computer readable medium having computer-executable instructions stored thereon to create the extraction profile.

The extraction profile can, in various examples, be created with a number of search mapping rules functionalized to provide access to the particular web site or web page based on entry of a number of search queries. During extraction profile creation, a person acting as a trainer, for example, on behalf of a website owner, can create the extraction profile for the web site using instructions that specify how content of the web site or web page can be searched. For example, the search mapping rules can specify that search queries (e.g., using a number of search terms, keywords, etc.) can be effectuated using a particular web site's own search capabilities and/or using a particular external search engine (e.g., a limited applicability and/or accessibility search engine or a widely applicable and/or accessible search engine, such as Google, among other possibilities).

The extraction profile also can, in various examples, be created with a number of extraction rules functionalized to extract the subset of the content from the particular type of web page and not to extract a remainder of the content. The extraction rules can specify, using patterns in Uniform Resource Locators (URLs) and/or page content, how the particular web sites or web pages cluster into different groups, where all the web sites or web pages in a group have the same structure.

For each of these groups, the trainer can choose a representative sample web site or web page and select the main content of the web page or use a particular user interface (e.g., international application no. PCT/CN2009/075545 (publication no. WO2011/072434) or international application no. PCT/CN2009/075117 (publication no. WO2011/063561), which are incorporated herein by reference in their entireties) to select the main content of the web page, saving this as the extraction rules for this group of web sites or web pages. The trainer can test the extraction rules on other web sites or web pages, and if the extraction rules do not extract an intended subset of the content, the main content selection can be adjusted and/or clustering specifications can be adjusted, among other possible adjustments, until main content is satisfactorily and automatically extracted from a test sample of web sites or web pages. An example of an extraction rule is an XML Path Language (Xpath) query, which can specify hierarchical paths into the tree structure of a target web page. A more sophisticated extraction rule can store an annotated version of a web page's tree structure, for comparison with a tree structure of a target page to find a possible equivalent of the annotated content.

Extraction profiles for web sites or web pages, including search mapping and extraction rules, can, in various examples, be stored in client computers 102, portable communication devices 103, and/or server computers 104 configured to communicate via a network 106, as shown in FIG. 1. A web browser client or a mobile application client can be implemented and, when a search query is input through the client (e.g., by an end user or automated instructions, among other means of input), the extraction profile can use the search mapping rules to execute a search.

A plurality of extraction profiles can be created that are each customized for a particular type of web site or web page. For each of the web sites or web pages that match a search query, a matching extraction rule can be used for extracting the main content. The extracted content can, in various examples, be combined and transformed into a displayable format. In some examples, transforming the subset of the content into the displayable format includes transforming the subset of the content into a displayable format that differs from a format of the particular type of web site or web page.

In some examples, the extraction profile can be created with a number of extraction rules enabling a link to be utilized such that the subset of the content is extractable from a plurality of linked web pages. For example, a displayable format of main content can be assembled from multiple web pages (e.g., connected by a “next page” link, an embedded link, such as in a news story, among other examples) in a single web site. Further, a displayable format of main content can, in some examples, be assembled from multiple web pages (e.g., connected through a portal page with a “go to” link to a news story, among other examples) in multiple web sites.

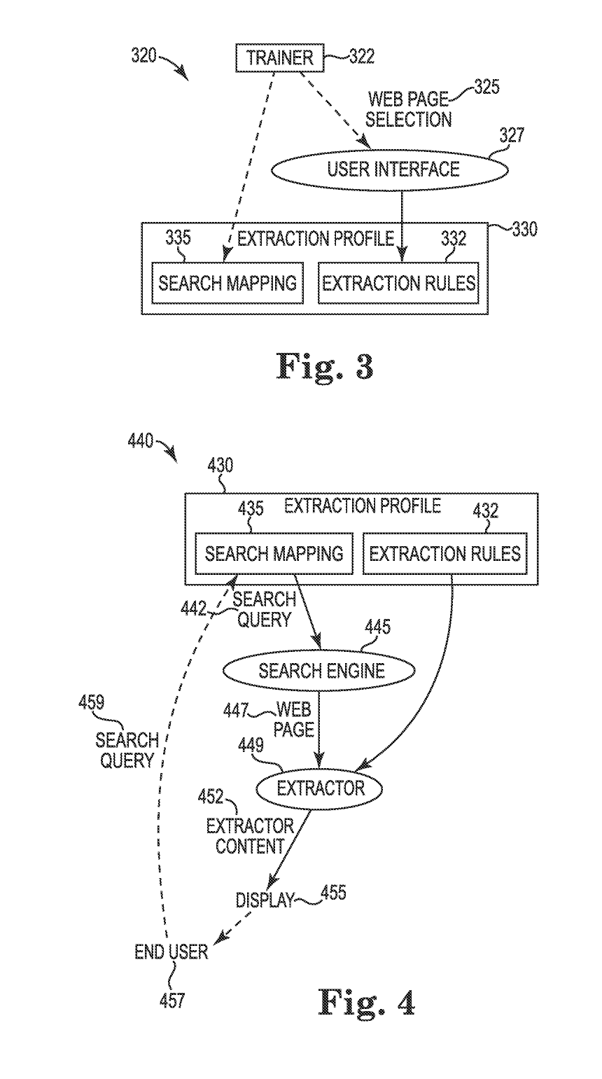

FIG. 3 illustrates an example of creating an extraction profile according to the present disclosure. The example of creating the extraction profile 320 illustrated in FIG. 3 includes a trainer 322, as described herein, that executes selection of a particular web site or web page 325. Following access to the particular web site or web page 325, the trainer 322 can operate through a user interface 327 to create a set of extraction rules 332 for the extraction profile 330 customized for the particular web site or web page.

As described herein, the set of extraction rules can, in various examples, be a number of extraction rules functionalized to extract a subset of content from a particular type of web page and not to extract a remainder of the content. In various examples, through the user interface 327, the trainer can create extraction rules that select the main content of the web site or web page or use a particular programmable apparatus (e.g., international application no. PCT/CN2009/075545 (publication no. WO2011/072434) or international application no. PCT/CN2009/075117 (publication no. WO2011/063561), which are incorporated herein by reference in their entireties) connected to, or functioning as, the user interface 327 to select the main content of the web page, saving decisions for the subset of content to extract as the extraction rules for this particular type of web page.

As shown in FIG. 3, the extraction profile 330 also can, in various examples, include search mapping rules 335. As described herein, the extraction profile can, in various examples, include a number of search mapping rules functionalized to provide access to a particular web site or web page based on entry of a number of search queries. For example, a person acting as a trainer on behalf of a website owner can create the extraction profile for the web site using instructions that specify how content of web sites or web pages can be searched. Such instructions for searching for a particular web site or web page can be saved as search mapping rules 335 for the extraction profile 330.

Profile driven extraction can collect and save web page data associated with the selection of portions of web pages, determine by the most user desirable content of the web page based, at least partially, on a popular selection by other users' or a “crowd's” previous selections of text, images, and other content on the web page, web pages that are similar to the web page, or other web pages. In the present disclosure, this is accomplished by a trainer, as described herein, requesting the web page from a web page server over the network using the appropriate network protocol (e.g., Internet Protocol (“IP”)), and requesting web page data from a selection data storage device. Illustrative processes for identifying the most user desirable content of the web page are described in more detail below.

To enable implantation of profile driven extraction, a computing device can include various hardware components. Among these hardware components may be at least one processor, at least one data storage device, peripheral device adapters, and a network adapter. These hardware components may be interconnected through the use of one or more buses and/or network connections. In one example, the processor, data storage device, peripheral device adapters, and the network adapter may be communicatively coupled via bus.

The present disclosure describes various methods, devices, and systems for profile driven extraction of user desirable or main content from a web site or web page using a trainer's previous markups of content selections in the same or similar web sites or web pages. There exist various types of content on any given web page that a user of a web page may not necessarily want to utilize. Some of the potentially unwanted content may include background imagery, advertisements, navigational menus, headers, footers, as well as separate links to additional content located throughout the Internet. Therefore, it is advantageous for a user of a web page to have those portions of the web page already selected that the user wants to edit, view, print, present, or otherwise utilize. Additionally, it is also advantageous to save any extraction profile associated with a web page related to those portions previously selected for utilization by the user. Therefore, when the user of the web page accesses the same or a similar web page, the user desirable content of a web page is selected based, at least partially, on the types of content previously selected for that web page or a similar web page.

Various challenges arise in attempting to manually select user desirable content from a web page. One challenge is the various types of web pages used. Specifically, many different templates are used to create the various types of web pages on the Internet and this may add additional difficulty in trying to retrieve the pertinent content in a more convenient way. Another challenge is to select desirable content from web pages which may be arbitrary because the web page does not include a template. It is further challenging to select the desirable content or at least the “main content” of the web page when most web pages on the Internet include various types of unwanted content such as text, images, videos, and flash objects. Therefore, determining what is and is not wanted content can be difficult if all of these types of content are present in any given web page. To help with this, profile driven extraction may be used to not only determine a relative ordering of level of appeal of content but also to determine whether content can be categorized as “desirable” or “main” content.

Further, as used herein, the terms “main content,” “user desirable content,” or “viewer desirable content” are meant to be understood broadly as that content on a web site or web page that a user wishes to view, utilize, or adapt for any purpose. Indeed, the present disclosure may refer to “desirable” content within a web site or web page that is meant to be understood as those sections of text, images, or any other content on a web site or web page that the user may wish to view, utilize, or adapt, and that is separate from any other undesirable content within a web site or web page.

Even further, as used herein, the term “web page data” is meant to be understood broadly as any data relating to a web page. For example, web page data may include at least one of the web page's Uniform Resource Locator (URL); the web page's Document Object Model (DOM); information relating to the structure and layout of a Document Object Model (DOM) tree of the web page; the layout and structure of any nodes within the Document Object Model (DOM) tree; content of a web page or nodes previously or currently selected by a trainer within a Document Object Model (DOM) tree; content of a web page or nodes not previously or currently selected by a trainer within a Document Object Model (DOM) tree; any data relating to the amount or characteristics of any type of content of the web page selected or not selected by a trainer, an individual, an entity; or combinations of these. Web page data may additionally include any metadata associated with or describing any of the above mentioned types of data. Still further, web page data may also include any data or metadata relating not only to the content of a web page a trainer has selected from any one web page in the past, but may also include information relating to when and how often the trainer had previously viewed, utilized, or adapted a web site or web page or content on a web site or web page.

Further, as used herein, the term “sub-node” is meant to be understood broadly as any node within a Document Object Model (DOM) tree which has at least one node located on a higher level in the hierarchal order of the Document Object Model (DOM) tree. Therefore, a sub-node may be a sub-node of a node which itself is a sub-node. Additionally, a sub-node may also comprise or have associated with it a number of sub-nodes itself.

Still further, as used herein, the term “similar web page” is meant to be understood broadly as any web page having similar characteristics as compared to another web page. For example, a similar web page may be similar in the type of template used to arrange the text, images, or other content displayed on the web page. A similar web page may also be similar because, although the web page address or Uniform Resource Locator (URL) is not entirely identical, the domain name within the Uniform Resource Locator (URL) is the same. Additionally, a similar web page may be similar in the content displayed on the web page. Similarly, as used herein, the term “similar web page data” is meant to be understood broadly as any web page data having similar characteristics as compared to other web page data. For example, a number of web pages' Document Object Model (DOM) trees may contain certain nodes that are similar to each other because, for example, the content contained in those respective nodes is equivalent. As described herein, web page data may be any type of data associated with the web page that allows a trainer and/or a computing device implementation of profile driven extraction to select those user desirable portions of a web page.

FIG. 4 illustrates an example of a system for profile driven extraction according to the present disclosure. The profile driven extraction system 440 illustrated in FIG. 4 includes an extraction profile 430 having extraction rules 432 and search mapping rules 435, in various examples as described herein.

The search mapping rules 435 can, in various examples, include rules that specify that query terms 442 used to find a number of particular web sites or web pages having matching content are to be directed to a particular search engine 445. As described herein, the search mapping rules 435 can, for example, specify that a search query 442 be effectuated using a particular search engine 445 (e.g., a particular web site's own search capabilities and/or using a particular external search engine, among others) to enable access to a particular web page 447 having content that at least partially matches terms used in the search query 442. To access the particular web site or web page can include accessing a network connection with the computing device.

In some examples of the present disclosure, an extractor module 449 can effectuate extraction, receipt, storage, and/or formatting (e.g., combination and/or arrangement of a number of portions) of the subset of content extracted from the web page 477 according to the extraction rules 432. In some examples, a number of processors (not shown), possibly in association with the extractor module 449, can effectuate the extraction and/or formatting.

Extractor content 452 (e.g., the subset of content extracted from the web page 477 according to the extraction rules 432) can be sent after formatting from the extractor 449 to a display apparatus 455 (e.g., a screen or monitor associated with a client computer, a portable communication device having mobile application(s), and/or a networked server computer) for display of reformatted text and/or visual images.

In some examples, an end user 457 can view the display apparatus 455. The end user can interact with, for example, a web browser client and/or a mobile application client (not shown) to provide an original and/or an additional search query 459 to the extraction profile 430 stored in the application server of the computing device. The search query 459 can be effectuated using the search mapping rules 435, which may differ from the search mapping rules used for the original search query 442. That is, which search mapping rules are actually utilized can depend upon the actual search terms, keywords, etc., of each search query because the search mapping rules (e.g., entered by the trainer) may be customized (e.g., stored) based upon which search terms, keywords, etc., are included in the search query.

Accordingly, the profile driven extraction system 440 can, in various examples, include an extraction profile 430 for a particular type of web site or web page stored in an application server, where the extraction profile 440 includes search mapping rules 435 and extraction rules 432. The system can include a web browser client or a mobile application client to enter a number of search queries 442, 459, a processor (not shown) to execute the extraction profile 430 by executing a search 445 for a particular web site or web page based upon the number of search queries 442, 459, executing access to the particular web site or web page 447, and executing the extraction rules 432 for the particular type of web site or web page 447, and an extractor 449 to receive and save an extracted subset of content from the particular web site or web page 447.

In various examples, after the extractor content 452 has been displayed to the end user, the end user 457 may further be allowed to adjust the content selection by adjustment of the extraction rules. That is, in addition to the content selected by the computing device based on previous selections made by trainer 322, the end user 457 may select additional portions and/or alternative portions of the web page 447. The end user may further exclude portions of the web page 447 selected by the trainer 322 from being part of the user desirable content selection. For example, these alterations may be done by clicking on and dragging a number of control points located around or otherwise associated with the selected portions of the selected content in the extraction rules 432 shown on a user interface of a computing device. Still further, the end user may be allowed to, for example, drag a cursor over additional portions of the web page 447 so as to further select a separate portion of the web page 447 that is not close to the previously selected portions selected by the trainer 322. In this case, the end user may create a new block or section within the content of the web page separate and distinct from the previously selected portion while still excluding those undesirable sections positioned between those two portions. Therefore, this addition and subtraction of the portions previously selected by the trainer 322 within the web page provides for a more effective and user-friendly means of obtaining those desirable portions of the web page within the parameters of profile driven extraction as described herein.

In various examples, the application server can store a plurality of extraction profiles 430 each customized for a particular type of web site or web page. In some examples, the extracted subset of the content is a number of separate data blocks and the extractor 449 combines the number of separate data blocks into a format (e.g., the extractor content 452) that differs from a format in which all data blocks are originally presented on the particular web page. A monitor, for example, associated with the web browser client or the mobile application client can be included in the system to display the combined extracted subset of the content (e.g., the extractor content 452).

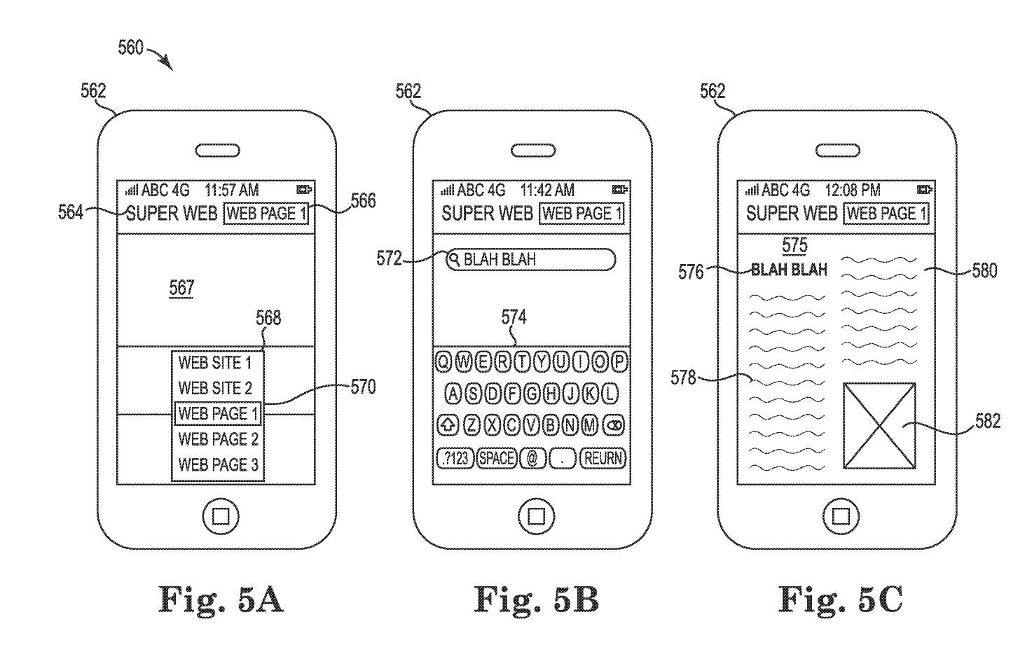

FIGS. 5A-5C illustrate an example implementation of profile driven extraction according to the present disclosure. The example implementation 560 illustrated in FIGS. 5A-5C shows a portable communication device 562 configured to communicate via a network. The portable communication device 562 is shown in FIGS. 5A-5C is an example implementation and does not limit use of profile driven extraction to such devices. That is, the profile driven extraction described in the present disclosure can be implemented in any computing device configured to communicate via a network, including client computers, portable communication devices, and/or server computers, among others.

In the example illustrated in FIG. 5A, the portable communication device 562 is shown connected to the network (e.g., through a home page 564 of a web browser). In some examples, the home page 564 can have a search window 566 for entry of search queries and/or an address to enable access to a particular web site or web page. The home page 564 also can have a screen 567 for display of text entered by an end user and text and/or images accessed at particular web sites or web pages. The home page 564 also can display a list of saved web sites and web pages 568 (e.g., in a scroll down list of favorites of the end user). As shown in FIG. 5A, a particular web page 570 can be selected from the list 568, which appears in the search window 566. Entries to the search window 566 are not, however, limited to those entries in the list of saved web sites and web pages 568. In some examples, the list of saved web sites and web pages 568 can correspond to a list of web sites and web pages that each have a customized extraction profile stored in the application server.

In the example illustrated in FIG. 5B, the portable communication device 562 includes a search query field 572 in which a search query, as described herein, can be entered. The search query can be entered in the search query field 572 by an end user utilizing, for example, a keyboard display 574 of the portable communication device 562, copying and pasting, or otherwise importing the search query. As described herein, the search query in the search query field 572 is effectuated by search mapping rules that can include the search query being directed to a particular search engine, which facilitates access to a particular web site or web page that includes at least some items included in terms, keywords, etc., of the search query. In addition, a particular web site or web page can be selected (e.g., web page 1 as shown in the search window 566), which may have its own search engine, in which the search query can be effectuated.

In the example illustrated in FIG. 5C, the portable communication device 562 has accessed the particular web site or web page that includes at least some items included in terms, keywords, etc., of the search query. As shown in a result screen 575, implementation of the extraction profile, as described herein, has extracted a subset of the content from the accessed particular web site or web page that includes at least some items included in terms, keywords, etc., of the search query. For example, the extracted subset can include a title 576, a first portion of text 578, a second portion of text 580 that may have originally been presented in a location of the accessed particular web site or web page separate from the first portion of the text 576, and/or an image 582 (drawing, diagram, chart, table, digital or analog photograph, and/or map, among other types of images). Any number of text portions and/or images, among other possibilities, can be extracted and combined.

The extracted subset can be transformed into a displayable format (e.g., to fit the result screen 575 of the portable communication device 562) that is reformatted relative to, for example, a format of the total content as originally presented in a number of locations in the accessed particular web site or web page. Such reformatting can compensate for the extracted subset coming from separate locations in the accessed particular web site or web page, which also may originally have had different print styles, print sizes, color schemes, languages, etc., which can be harmonized by the extraction profile for display in one coherent document. Such reformatting also can compensate for the extraction profile not extracting a remainder of the content from the accessed particular web site or web page (e.g., background imagery, advertisements, navigation menus, and links to additional content, among other content that may not convey information of relevance and/or interest to the individual).

As described herein, online advertising may be of little interest or relevance to an individual seeking information on an unrelated matter (e.g., an end user accessing particular web sites or web pages). That is, many electronically exchanged documents, including both text and image documents, contain little or no commercial content related to such advertisements. As such, the profile driven extraction described herein can provide a subset of relevant content in an electronic document, with reduced amounts of advertisements, among other undesired material, for end users. This can include removing advertisements from documents when an electronic document (e.g., accessible from a client computer by a network link) is printed by the end user. This can also include removing commercial content from electronic word processing documents, PDFs, image files and the like, when the same are printed by the end user.

In some examples, the electronic document content that the user has accessed and may choose to preserve by printing (e.g. web sire, web page, PDF, word processing document, image file, etc.) is identified and analyzed to determine its underlying subject matter and/or a taxonomic analysis to determiner information. Next, commercial content (e.g., advertisements and/or coupons not pertinent to the underlying subject matter) may be identified. Once the commercial content has been identified, a new, printable document can be created and reformatted for printing that includes the electronic document content and excludes the commercial content. In some examples, the newly formatted, printable document can exclude other content that the end user does not wish to include in a printout (e.g., footers, headers, source formatting, comments and/or annotations, citations, web site navigation features, hyperlinks to other web pages, and online advertisements, and the like). A printout can result that has improved formatting with less clutter by excluding such content.

Examples of the present disclosure may include methods, devices, and systems, including executable instructions and/or logic to facilitate and/or implement profile driven extraction, which can be executed in connection with particular applications. Processing resources can include one or more processors able to access data stored in memory to execute the comparisons, actions, functions, etc., described herein. As used herein, “logic” is an alternative or additional processing resource to execute the comparisons, to actions, functions, etc., described herein, which includes hardware (e.g., various forms of transistor logic, ASICs, etc.), as opposed to computer executable instructions (e.g., machine readable instructions, such as software, firmware, etc.) stored in memory and executable by a processor.

In a network of computing devices, a number of network devices can be networked together in a Local Area Network (LAN) and/or a Wide Area Network (WAN), a personal area network (PAN), the WWW, and/or the Internet, among other networks, via routers, hubs, switches, and the like. As used herein, a network device (e.g., a device having processing and memory resources and/or logic that is connected to a network) can include a number of switches, routers, hubs, bridges, etc.

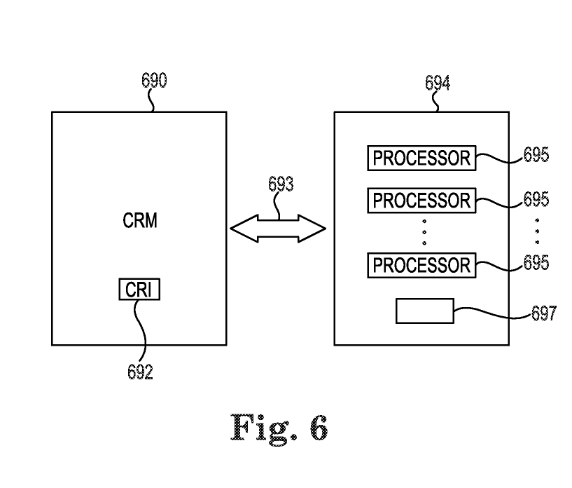

FIG. 6 is a block diagram illustrating an example of a computing device readable medium (CRM) with processing resources for profile driven extraction according to the present disclosure. For example, the CRM 690 can be in communication via a communication path 693 with (e.g., operatively coupled to) a number of computing devices 694 having a number of processing resources 695-1, 695-2, . . . , 695-N (e.g., one or more processors). The CRM 690 can include computing device readable instructions (CRI) 692 to cause the number of computing devices 694 to, for example, perform profile driven extraction, which can be executed in connection with particular applications.

For example, as described in the present disclosure, a non-transitory computer readable medium can have computer-executable instructions stored thereon for profile driven extraction. The computer-executable instructions can, in various examples, be executable by a processor to access a particular web site or web page via search mapping with a computing device, extract a subset of content from a particular type of web page according to a number of extraction rules of an extraction profile created for the particular type of web page, and transform the subset of the content into a displayable format.

In various examples, to access the particular web site or web page via search mapping includes to connect to a search engine of a particular web site or to connect to a general network accessible search engine and execute a search based upon a number of entered search queries. In various examples, to extract the subset of content includes to extract particular data blocks and not to extract a remainder of data blocks as defined by the number of extraction rules of the extraction profile. In various examples, to transform the subset of the content into the displayable format includes to combine extracted particular data blocks in an order in which the extracted particular data blocks are originally presented on the particular web page.

The number of computing devices 694 can also include memory resources 697, and the processing resources 695-1, 679-2, . . . , 695-N can be coupled to these memory resources 697 in addition to those of the CRM 690. The CRM 690 can be in communication with the number of computing devices 694 having processing resources of more or fewer than 695-1, 695-2, . . . , 695-N. The number of computing devices 694 can be in communication with and/or receive from a tangible non-transitory CRM 690 storing a set of stored CRI 692 executable by one or more of the processing resources 695-1, 695-2, . . . , 695-N for image analysis and/or implementation of feature detection in combination with feature descriptors, which can be executed in connection with particular applications. The stored CRI 692 can be an installed program or an installation pack. With an installation pack, the memory, for example, can be a memory managed by a server such that the installation pack can be downloaded.

Processing resources 695-1, 695-2, . . . , 695-N can execute the CRI 692 to, for example, facilitate and/or implement profile driven extraction, which can be executed in connection with particular applications. A non-transitory CRM (e.g., CRM 690), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Btu-ray discs (BD), compact discs (CD), and/or a solid state drive (SSD), etc., as well as other types of CRM.

The non-transitory CRM 690 can be integral, or communicatively coupled, to a computing device, in either in a wired or wireless manner. For example, the non-transitory CRM 690 can be an internal memory, a portable memory, a portable disk, or a memory located internal to another computing resource (e.g., enabling CRI 692 to be downloaded over the Internet).

The CRM 690 can be in communication with the processing resources 695-1, 695-2, . . . , 695-N via the communication path 693. The communication path 693 can be local or remote to a machine associated with the processing resources 695-1, 695-2, . . . , 695-N. Examples of a local communication path 693 can include an electronic bus internal to a machine such as a computing device where the CRM 690 is one of volatile, non-volatile, fixed, and/or removable storage medium in communication with the processing resources 695-1, 695-2, . . . , 695-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 693 can be such that the CRM 690 is remote from the processing resources 695-1, 695-2, . . . , 695-N such as in the example of a network connection between the CRM 690 and the processing resources 695-1, 695-2, . . . , 695-N. That is, the communication path 693 can be a network connection. Examples of such a network connection can include a LAN, a WAN, a PAN, and the Internet, among others. In such examples, the CRM 690 may be associated with a first computing device and the processing resources 695-1, 695-2, . . . , 695-N may be associated with a second computing device.

It is to be understood that the above description has been made in an illustrative fashion, and not a restrictive one. Although specific examples for methods, devices, systems, computing devices, and instructions have been illustrated and described herein, other equivalent component arrangements, instructions, and/or device logic can be substituted for the specific examples shown herein.

What is claimed:

1. A profile driven extraction method, comprising:
utilizing an extraction profile created for extracting a subset of content from a particular web site or type of web page;
extracting the subset of the content from a number of web pages with a computing device; and
transforming the subset of the content with the computing device into a displayable format.

2. The method of claim 1, further comprising a trainer creating the extraction profile for the particular type of web site or web page.

3. The method of claim 2, wherein the trainer creating the extraction profile for the particular web site or type of web page comprises selecting the trainer from a group that comprises:
an entity associated with a web site that provides access to the particular type of web site or web page;
a hardware, firmware, or software provider that provides computer-executable instructions that comprise the extraction profile; and
a computer readable medium having computer-executable instructions stored thereon to create the extraction profile.

4. The method of claim 1, further comprising creating the extraction profile with a number of search mapping rules functionalized to provide access to the particular web site or web page based on entry of a number of search queries.

5. The method of claim 1, further comprising creating the extraction profile with a number of extraction rules functionalized to extract the subset of the content from the particular type of web page and not to extract a remainder of the content.

6. The method of claim 5, wherein creating the extraction profile with the number of extraction rules comprises enabling a link to be utilized such that the subset of the content is extractable from a plurality of linked web pages.

7. The method of claim 1, wherein the method comprises creating a plurality of extraction profiles each customized for a particular type of web site or web page.

8. A non-transitory computer readable medium having computer-executable instructions stored thereon for profile driven extraction, the computer-executable instructions comprising instructions executable by a processor to:
access a particular web site or web page via search mapping with a computing device;
extract a subset of content from a particular type of web page according to a number of extraction rules of an extraction profile created for the particular type of web page; and
transform the subset of the content into a displayable format.

9. The medium of claim 8, wherein to access the particular web site or web page via search mapping comprises to connect to a search engine of a particular web site or to connect to a general network accessible search engine and execute a search based upon a number of entered search queries.

10. The medium of claim 8, wherein to extract the subset of content comprises to extract particular data blocks and not to extract a remainder of data blocks as defined by the number of extraction rules of the extraction profile.

11. The medium of claim 10, wherein to transform the subset of the content into the displayable format comprises to combine extracted particular data blocks in an order in which the extracted particular data blocks are originally presented on the particular web page.

12. A profile driven extraction system, comprising:
an extraction profile for a particular type of web site or web page stored in an application server, wherein the extraction profile comprises search mapping rules and extraction rules;
a web browser client or a mobile application client to enter a number of search queries;
a processor to execute the extraction profile by executing a search for a particular web site or web page based upon the number of search queries, executing access to the particular web site or web page, and executing the extraction rules for the particular type of web site or web page; and
an extractor to receive and save an extracted subset of content from the particular web site or web page.

13. The system of claim 12, wherein the extracted subset of the content is a number of separate data blocks and the extractor combines the number of separate data blocks into a format that differs from a format in which all data blocks are originally presented on the particular web page.

14. The system of claim 13, comprising a monitor associated with the web browser client or the mobile application client to display the combined extracted subset of the content.

15. The system of claim 12, wherein the application server stores a plurality of extraction profiles each customized for a particular type of web site or web page.
